(19) United States
(12) Patent Application Publication
(10) Pub. No.: US 2021/0072827 A1
(43) Pub. Date: Mar. 11, 2021

(54) LINE-OF-SIGHT INPUT DEVICE, METHOD OF LINE-OF-SIGHT INPUT, AND LINE-OF-SIGHT INPUT SYSTEM

(71) Applicant: ORYLAB INC., Tokyo (JP)

(72) Inventor: Kentaro YOSHIFUJI, Tokyo (JP)

(73) Assignee: ORYLAB INC., Tokyo (JP)

(21) Appl. No.: 17/100,966

(22) Filed: Nov. 23, 2020

Related U.S. Application Data
(63) Continuation of application No. PCT/JP2019/021937, filed on Jun. 3, 2019.

(30) Foreign Application Priority Data
Jun. 7, 2018 (JP) 2018-109288

(51) Int. Cl. G06F 3/01; G02B 27/00; G02B 27/01; G06F 3/023; G06F 3/038

(52) U.S. Cl. CPC G06F 3/013; G02B 27/0093; G06F 3/038; G06F 3/023; G02B 27/0103

(57) ABSTRACT

A line-of-sight input device includes a line-of-sight identification section that identifies a line of sight of a user, a reference setting section that causes a storage section to store, as a reference line of sight, the line of sight being identified when the user is looking at a reference position in a display fixed to the head of the user; a display control section that causes the display to display a partial region of an entire region representing input elements that can be inputted, and changes a position of the partial region in the entire region, the partial region being displayed to the display on the basis of a relationship between the reference line of sight and the line of sight; and an input receiving section that receives an input of an input element positioned in a region including the reference position within the partial region displayed on the display.

### CROSS-REFERENCE TO RELATED APPLICATIONS

The present application is a continuation application of International Application number PCT/JP2019/021937, filed on Jun. 3, 2019, which claims priority under 35 U.S.0 § 119(a) to Japanese Patent Application No.2018-109288, filed on Jun. 7, 2018. The contents of this application are incorporated herein by reference in their entirety.

### BACKGROUND

### Technical Field

This disclosure relates to a line-of-sight input device, a method of line-of-sight input, a line-of-sight input program, and a line-of-sight input system for receiving an input on the basis of a user's line of sight. Conventionally, a line-of-sight input system for inputting by using a user's line of sight has been developed for users who have difficulty performing operations with their limbs due to physical disabilities or the like. Patent Document 1, Japanese Unexamined Patent Application Publication No. 2018-18449, describes a system that detects movement of a line of sight on the basis of an image of the eyes of a user and performs operations corresponding to the movement of the line of sight.

The system described in Patent Document 1 performs a calibration for identifying a relationship between a position of the line of sight and a position of a screen by causing the user to sequentially gaze at nine points displayed on the screen, prior to detecting the movement of the line of sight. There was an issue, however, that such a calibration imposed a heavy burden on the user to sequentially gaze at a plurality of points.

### SUMMARY

The present disclosure focus on this point and provides a line-of-sight input device, a method of line-of-sight input, a line-of-sight input program, and a line-of-sight input system which can reduce a burden on a user when inputting a line-of-sight.

A line-of-sight input device according to a first aspect of the present disclosure is the line-of-sight input device for a user to input information using a line of sight and includes: a line-of-sight identification section that identifies the line of sight of the user; a reference setting section that causes a storage section to store, as a reference line of sight, the line of sight being identified by the identification section when the user is looking at a reference position in a display fixed to the head of the user; a display control section that causes the display to display a partial region of an entire region representing a plurality of input elements that can be inputted to the line-of-sight input device, and changes a position of the partial region in the entire region, the partial region being displayed to the display, on the basis of a relationship between the reference line of sight and the line of sight identified by the line-of-sight identification section; and an input receiving section that receives an input of an input element positioned in a predetermined region including the reference position within the partial region displayed on the display.

A method of line-of-sight input according to a second aspect of the present disclosure is the method of line-of-sight input for a user to input information using a line of sight in a line-of-sight input device and performed by a processor, and includes: identifying the line of sight of the user; causing a storage section to store, as a reference line of sight, the line of sight being identified in the identifying when the user is looking at a reference position in a display fixed to the head of the user; causing the display to display a partial region of an entire region representing a plurality of input elements that can be inputted to the line-of-sight input device, and changing a position of the partial region in the entire region, the partial region being displayed to the display, on the basis of a relationship between the reference line of sight and the line of sight identified in the identifying; and receiving an input of an input element positioned in a predetermined region including the reference position within the partial region displayed on the display.

A line-of-sight input system according to a third aspect of the present disclosure has a head-mounted device fixed to the head of a user and a line-of-sight input device that transfers signals from and to the head-mounted device, wherein the head-mounted device includes a display fixed to the head of the user so that the user can perform visual recognition, the line-of-sight input device includes: a line-of-sight identification section that identifies a line of sight; a reference setting section that causes a storage section to store, as a reference line of sight, the line of sight being identified by the identification section when the user is looking at a reference position in the display; and a display control section that causes the display to display a partial region of an entire region representing a plurality of input elements that can be inputted to the line-of-sight input device, and changes a position of the partial region in the entire region, the partial region being displayed to the display, on the basis of a relationship between the reference line of sight and the line of sight identified by the line-of-sight identification section; and an input receiving section that receives an input of an input element positioned in a predetermined region including the reference position within the partial region displayed on the display.

### BRIEF DESCRIPTION OF THE DRAWINGS

FIG. 1 is a schematic diagram showing a line-of-sight input system according to the present embodiment.

FIG. 2 is a block diagram showing the line-of-sight input system according to the present embodiment.

FIGS. 3A and 3B are each a front view of a head-mounted device according to the present embodiment.

FIG. 4 is a schematic diagram showing a display section displaying a setting screen.

FIG. 5 is a schematic diagram showing input elements that can be input by a user.

FIG. 6 is a schematic diagram showing a process of changing a display region.

FIG. 7 is a schematic diagram showing the display section displaying an input screen.

FIG. 8 is a flowchart showing a method of line-of-sight input according to the present embodiment.

### DETAILED DESCRIPTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Configuration of a Line-of-Sight Input System S

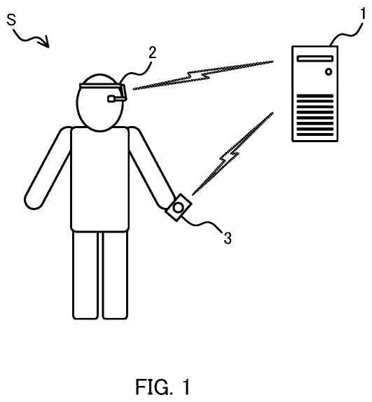

FIG. 1 is a schematic diagram showing a line-of-sight input system S according to the present embodiment. The line-of-sight input system S includes a line-of-sight input device 1, a head-mounted device 2, and an operation device 3. The line-of-sight input system S may include other devices such as a server, a terminal, and the like.

The head-mounted device 2 is a device that can be fixed to the head of a user, displays information received from the line-of-sight input device 1, acquires information for detecting a line of sight of the user, and transmits the acquired information to the line-of-sight input device 1. The operation device 3 is a device that can be held by the user and receives a user's operation. The operation device 3 may be provided integrally with the head-mounted device 2.

The head-mounted device 2 and the operation device 3 are connected to the line-of-sight input device 1 wirelessly by a wireless communication technique such as Bluetooth (registered trademark), a wireless local area network (LAN), or the like, or in a wired manner by a cable. The head-mounted device 2 and the operation device 3 may be directly connected to the line-of-sight input device 1 or may be connected via networks such as the Internet.

The line-of-sight input device 1 is a computer that receives, by a method of line-of-sight input which will be described below, an input of an input element such as a character, a symbol, an icon, and the like from the user on the basis of the information received from the head-mounted device 2 worn by the user. The line-of-sight input device 1 may be configured to be integrated into the head-mounted device 2. That is, the head-mounted device 2 may have a function of the line-of-sight input device 1.

### Configuration of the Line-of-Sight Input System S

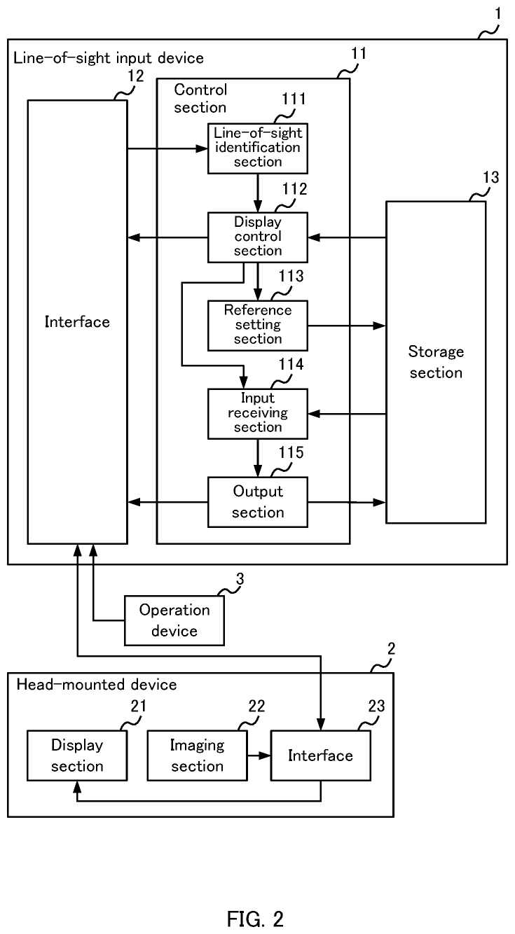

FIG. 2 is a block diagram showing the line-of-sight input system S according to the present embodiment. In FIG. 2, arrows indicate main data flows, and there may be data flows other than those shown in FIG. 2. In FIG. 2, each block indicates a configuration of a function unit, not a configuration of a hardware (device) unit. As such, the blocks shown in FIG. 2 may be implemented in a single device or separately in a plurality of devices. The transfer of data between the blocks may be performed via any means, such as a data bus, a network, a portable storage medium, or the like.

The operation device 3 includes an operation member such as a button, a switch, or a touch panel for receiving the user's operation. The operation device 3 detects the user's operation on the operation member and transmits a signal indicating the user's operation to the line-of-sight input device 1.

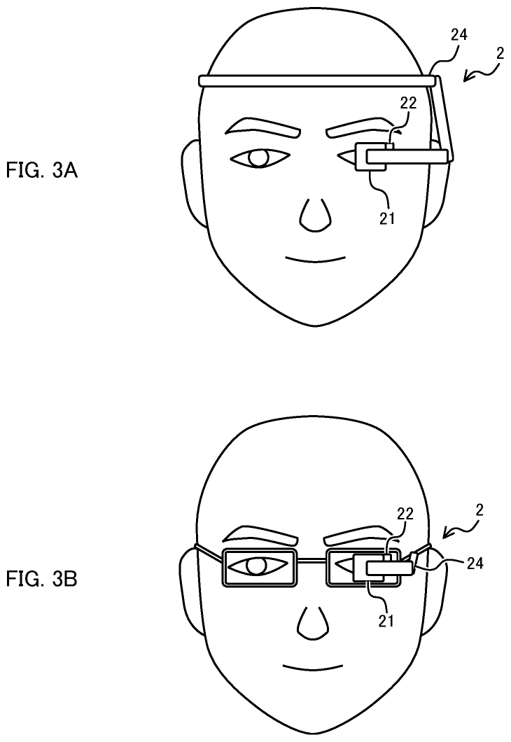

The head-mounted device 2 includes a display section 21, an imaging section 22, and an interface 23. The structure of the head-mounted device 2 will be described below with reference to FIG. 3. The interface 23 is a connection section for transferring signals between the head-mounted device 2 and the line-of-sight input device 1. The interface 23 performs a predetermined process on the signals received from the line-of-sight input device 1 to acquire data, and inputs the acquired data to the display section 21. Also, the interface 23 performs a predetermined process on data input from the imaging section 22 to generate a signal, and transmits the generated signal to the line-of-sight input device 1.

The display section 21 includes a display device such as a liquid crystal display for displaying various types of information. The display section 21 displays the information in accordance with the signals received from the line-of-sight input device 1.

The imaging section 22 is an image pick-up device that is provided on the head-mounted device 2 and captures a predetermined imaging area including the eye (eyeball) of the user wearing the head-mounted device 2. The imaging section 22 includes an imaging element such as a charge-coupled device (CCD) sensor, a complementary metal oxide semiconductor (CMOS) sensor, or the like. The imaging section 22 may perform imaging at a preset timing, or may perform imaging according to an imaging instruction received from the line-of-sight input device 1. The imaging section 22 transmits a signal indicating a captured image, which is an image captured by the imaging section 22, to the line-of-sight input device 1.

The line-of-sight input device 1 includes a control section 11, an interface 12, and a storage section 13. The control section 11 includes a line-of-sight identification section 111, a display control section 112, a reference setting section 113, an input receiving section 114, and an output section 115.

The interface 12 is a connection section for transferring signals between the head-mounted device 2 and the operation device 3. The interface 12 performs a predetermined process on signals received from both the head-mounted device 2 and the operation device 3 to acquire data, and inputs the acquired data to the control section 11. Also, the interface 12 performs a predetermined process on data input from the control section 11 to generate signals, and transmits the generated signals to the head-mounted device 2 and the operation device 3.

The storage section 13 is a storage medium including a read only memory (ROM), a random access memory (RAM), a hard disk drive, and the like. The storage section 13 pre-stores programs to be executed by the control section 11. Also, the storage section 13 stores (i) input element information indicating an input element such as a plurality of characters, symbols, and icons that can be input by the user, (ii) reference information indicating a reference line of sight which is set by the reference setting section 113, and (iii) input information indicating an input element, which is input by the user and received by the input receiving section 114. The storage section 13 may be provided outside the line-of-sight input device 1, and in such a case, the storage section 13 may transfer data with the control section 11 via the interface 12.

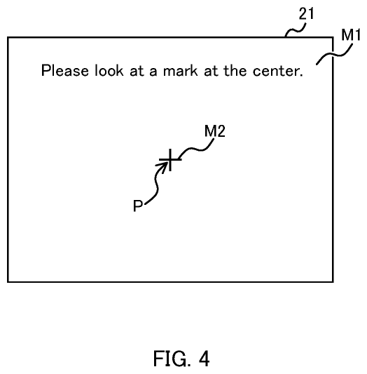

The control section 11 is, for example, a processor such as a central processing unit (CPU), and functions as the line-of-sight identification section 111, the display control section 112, the reference setting section 113, the input receiving section 114, and the output section 115 by executing the programs stored in the storage section 13. Functions of the line-of-sight identification section 111, the display control section 112, the reference setting section 113, the input receiving section 114, and the output section 115 will be described below with reference to FIG. 4 to FIG. 7. At least some of the functions of the control section 11 may be performed by an electric circuit. Further, at least some of the functions of the control section 11 may be executed by programs executed via the network.

The line-of-sight input system S according to the present embodiment is not limited to the specific configuration shown in FIG. 2. For example, the line-of-sight input device 1 is not limited to a single device, and may be configured by connecting two or more separated devices by wired or wireless connection.

### Configuration of the Head-mounted Device 2

FIGS. 3A and 3B are each a front view of the head-mounted device 2 according to the present embodiment. FIGS. 3A and 3B each represent a state in which the head-mounted device 2 is mounted on the user's head. The head-mounted device 2 of FIG. 3A has a fixing section 24 which is fixed to the user's head. For example, the fixing section 24 has a ring shape in which a part thereof is cut out, and has a structure to sandwich the head of the user. By this, the fixing section 24 directly fixes the display section 21 and the imaging section 22 of the head-mounted device 2 to the head of the user.

The head-mounted device 2 of FIG. 3B has a fixing section 24 which is fixed to glasses worn by the user. For example, the fixing section 24 has a structure in which a temple of the glasses is sandwiched with a clip or the like. By this, the fixing section 24 fixes the display section 21 and the imaging section 22 of the head-mounted device 2 to the head of the user via the glasses worn by the user.

The fixing section 24 is not limited to the structures shown in FIG. 3A and FIG. 3B, and may have other structures capable of fixing the display section 21 and the imaging section 22 to the head of the user.

As shown in FIG. 3A and FIG. 3B, the display section 21 and the imaging section 22 are fixed in front of one eye of the user (i.e., in front of the user's head) by the fixing section 24. Since the head-mounted device 2 is fixed to the head of the user, the display section 21 can make the user visually recognize the information being displayed regardless of where the user's head is facing, and the imaging section 22 can capture an image of the imaging area including the user's eye. In addition, since the head-mounted device 2 is fixed to the head of the user, a relative position between the display section 21 and the user does not change even if the user moves, and there is no need to perform a calibration again. In addition, since the display section 21 and the imaging section 22 are provided only in front of one eye of the user, the user can look ahead with one of his/her eyes while he/she enters characters with his/her other eye.

### Description of the Method of Line-of-Sight Input

### Calibration

In the method of line-of-sight input according to the present embodiment, the line-of-sight input device 1 first executes a calibration process. The calibration is to acquire in advance a line of sight that serves as the standard for the line-of-sight input. While executing the calibration, the line-of-sight identification section 111 periodically identifies the user's line of sight at predetermined time intervals. Specifically, the line-of-sight identification section 111 first acquires a captured image of the imaging area including the user's eye captured by the imaging section 22 of the head-mounted device 2.

Next, on the basis of the acquired captured image, the line-of-sight identification section 111 identifies the user's line of sight (i.e., an orientation of the user's eye). Since the head-mounted device 2 according to the present embodiment is fixed to the head of the user, the imaging section 22 is relatively fixed to the eye of the user. Therefore, as long as the head-mounted device 2 fixed to the head does not shift, a position of the entire eye (eyeball) does not move in the captured image, and only the orientation of the eye changes according to a position viewed by the user. Therefore, the user's line of sight corresponds to a position of the iris of the user (i.e., at least one of the pupil or the iris) in the captured image.

For this reason, the line-of-sight identification section 111 identifies, as the user's line-of-sight, a position of at least one of the pupil or the iris of the user (for example, a coordinate of the center of gravity of the pupil or the iris in the captured image) extracted from the acquired captured image. At this time, the line-of-sight identification section 111 extracts the position of at least one of the pupil or the iris of the user, for example, by performing pattern matching on the captured image.

The method with which the line-of-sight identification section 111 identifies the user's line of sight is not limited to the specific method described above, and may be other methods. For example, the line-of-sight identification section 111 may identify the user's line of sight on the basis of a positional relationship between (i) a standard point, corresponding to a bright spot on the inner corner of eye or the cornea and (ii) a moving point, corresponding to the pupil or the iris. In this case, since the standard point is fixed regardless of the line of sight and the moving point changes according to the line of sight, the line-of-sight identification section 111 identifies the relative position of the moving point with respect to the standard point as the user's line of sight. Also, for example, the line-of-sight identification section 111 may identify a line of sight as the user's line of sight by detecting movements of the eyeball (i.e., a rotation angle, a rotation speed, etc. of the eyeball.)

Concurrently with the user's line of sight being identified by the line-of-sight identification section 111, the display control section 112 transmits signals to the display section 21 of the head-mounted device 2 to display a setting screen for setting the reference line of sight.

FIG. 4 is a schematic diagram showing the display section 21 displaying the setting screen. The display section 21 displays, as the setting screen, a message M1 indicating an instruction for the user and a mark M2 indicating a reference position P.

The reference position P is a predetermined point in the display section 21 for the user to look at when setting the reference line of sight. In the present embodiment, the line-of-sight input device 1 performs the calibration using one reference position P, but the line-of-sight input device 1 may set the reference line of sight by performing a calibration using two reference positions P. The reference position P is, for example, the center point of the display section 21, but is not limited thereto, and may be, for example, a region having a predetermined shape (circle, square, or the like). The mark M2 is a mark prompting the user to look at a point at the reference position P, and for example, an intersecting portion of a cross mark corresponds to the reference position P.

The message M1 is information prompting the user to look at the point at the reference position P. In the present embodiment, the display section 21 displays a character string indicating the message M1, but a speaker provided in the head-mounted device 2 may output a voice indicating the message M1. Since the user who has looked at or heard the message M1 looks at the reference position P, the user's line of sight is oriented towards the reference position P.

After the display control section 112 has caused the display section 21 to display the setting screen, the reference setting section 113 identifies the user's line of sight when the user is looking at the reference position P as the reference line of sight. The reference setting section 113 may use the timing at which the user operates the operation device 3 to determine the timing at which the user is looking at the reference position P. In this case, the user operates the operation device 3 (for example, presses a button) while looking at the reference position P. The reference setting section 113 then identifies the reference line of sight when receiving a signal indicating the user's operation from the operation device 3.

Also, the reference setting section 113 may use the timing at which the user speaks a predetermined word in order to determine the timing at which the user is looking at the reference position P. In this case, while looking at the reference position P, the user inputs the voice indicating the predetermined word to a microphone provided in the head-mounted device 2. The reference setting section 113 then identifies the reference line of sight when receiving the voice indicating the predetermined word from the head-mounted device 2. The reference setting section 113 can use a well-known voice recognition technique to detect the predetermined word from the voice.

Also, the reference setting section 113 may automatically determine the timing at which the user is looking at the reference position P. In this case, the reference setting section 113 identifies the reference line of sight, for example, when a predetermined time has passed since the display section 21 displayed the setting screen, or when the predetermined time has passed since the user's line of sight stopped.

The reference setting section 113 then sets the reference line of sight by storing reference information indicating the identified reference line of sight to the storage section 13. The reference information may be an image of or the position of at least one of the pupil or the iris of the user (e.g., the coordinate of the center of gravity of the pupil or the iris in the captured image), identified as the reference line of sight.

### Receiving the Input of the Input Element

After the calibration is completed, the line-of-sight input device 1 receives the input of the input element from the user. In order to receive the input, the line-of-sight identification section 111 periodically identifies the user's line of sight at predetermined intervals. A method with which the line-of-sight identification section 111 identifies the user's line of sight is the same as in the calibration.

Concurrently with the user's line of sight being identified by the line-of-sight identification section 111, the display control section 112 transmits signals to the display section 21 of the head-mounted device 2, and performs control for displaying an input screen for receiving the input from the user. Specifically, the display control section 112 first acquires the input element information pre-stored in the storage section 13. The input element information is information indicating an input element such as a plurality of characters, symbols, and icons that can be input by the user. The icon is a figure associated with a predetermined instruction to a device such as a robot or a computer, for example, a specific operation of the robot, execution of specific software, or the like. The types of input element that can be input by the user (e.g., Japanese characters, English letters, numbers, symbols, etc.) may be switched according to the input from the user.

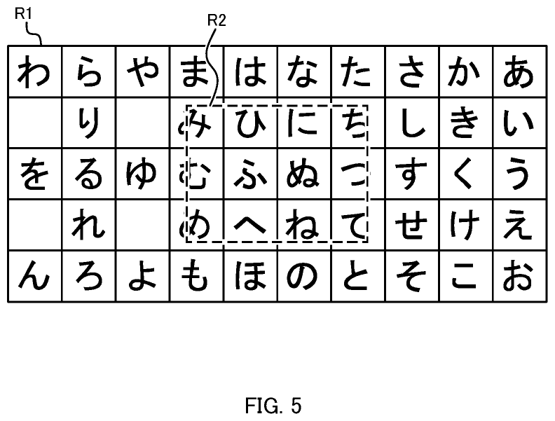

Next, the display control section 112 determines a display target on the display section 21 of the head-mounted device 2 among the input elements indicated by the acquired input element information. FIG. 5 is a schematic diagram showing input elements that can be input by the user. Specifically, the display control section 112 generates an entire region R1 in which all the input elements indicated by the input element information are arranged on a plane. The display control section 112 determines a display region R2, which is a partial region of the entire region R1, as the display target. The display region R2 includes a plurality of input elements that are part of all the input elements indicated by the input element information. The size of the display region R2 is set in advance according to the size of the display section 21 of the head-mounted device 2.

At the start of receiving the input from the user, the display region R2 in the entire region R1 is set to a predetermined position (initial position). For example, the initial position of the display region R2 is the center of the entire region R1. The initial position may be other positions of the entire region R1.

The display control section 112 transmits information indicating the determined display region R2 to the display section 21 of the head-mounted device 2 to display the input screen for receiving the input from the user. The display section 21, as the input screen, displays the plurality of input elements included in the display region R2.

Further, the display control section 112 changes the display region R2 in the entire region R1 on the basis of a relationship between the reference line of sight identified by the reference setting section 113 and a user's current line of sight (current line of sight) identified by the line-of-sight identification section 111.

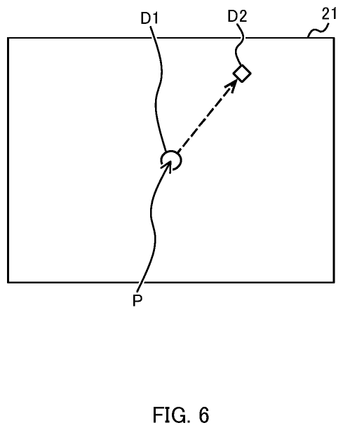

FIG. 6 is a schematic diagram showing a process of changing the display region R2. FIG. 6 represents a reference line of sight D1 identified by the reference setting section 113 and a current line of sight D2 identified by the line-of-sight identification section 111. In FIG. 6, for visibility, marks are shown at positions where the reference line of sight D1 and the current line of sight D2 are respectively projected onto the display section 21. The position at which the reference line of sight D1 is projected onto the display section 21 corresponds to the reference position P.

Specifically, the display control section 112 acquires reference information indicating the reference line of sight D1 identified by the reference setting section 113 from the storage section 13. Also, the display control section 112 acquires, as the current line of sight D2, the latest line of sight of the user identified by the line-of-sight identification section 111. The display control section 112 calculates a direction and a distance (i.e., vector) of the current line of sight D2 based on the reference line of sight D1. The distance of the current line of sight D2 based on the reference line of sight D1 is a difference between the position of the reference line of sight D1 and the position of the current line of sight D2. The display control section 112 may calculate the aforementioned distance, for example, on the basis of the coordinate of the center of gravity of the pupil or the iris in the captured image, or may calculate the aforementioned distance on the basis of the projected positions (coordinates) of the reference line of sight D1 and the current line of sight D2 on the display section 21.

The display control section 112 then determines a movement speed (i.e., a moving direction and a moving speed) for moving the display region R2 in the entire region R1 on the basis of the calculated direction and distance from the reference line of sight D1 to the current line of sight D2. The display control section 112 sets the direction from the reference line of sight D1 to the current line of sight D2 as the direction for moving the display region R2 in the entire region R1. In addition, display control section 112 sets the value calculated on the basis of a distance from the reference line of sight D1 to the current line of sight D2 in compliance with a predetermined rule as the speed at which the display region R2 is moved in the entire region R1.

Here, the display control section 112 increases the speed as the distance from the reference line of sight D1 to the current line of sight D2 increases, and decreases the speed as this distance decreases. When the distance from the reference line of sight D1 to the current line of sight D2 is less than or equal to a predetermined value (i.e., when the reference line of sight D1 and the current line of sight D2 are close to each other), the display control section 112 sets the speed to zero and stops the movement of the display region R2. For example, display control section 112 may calculate the speed in proportion to the distance from the reference line of sight D1 to the current line of sight D2, or may calculate the speed in a step-by-step (discontinuous) manner according to the increase in the distance from the reference line of sight D1 to the current line of sight D2. The display control section 112 determines the direction and the speed as the movement speed.

The display control section 112 repeats (i) determining the movement speed at predetermined time intervals, (ii) moving the display region R2 in the entire region R1 using the determined movement speed, and (iii) causing the display section 21 to display the display region R2 being moved. As a result, the display control section 112 can dynamically change the position and the movement speed of the display region R2 in the entire region R1 according to the user's current line of sight, and move an input element desired by the user to the display region R2.

In this manner, the display control section 112 calculates only the direction and distance from the reference line of sight to the current line of sight, and does not identify a precise coordinate of the line of sight on the display section 21. Therefore, in a line-of-sight adjustment by the reference setting section 113 described above, it is only necessary to set, as a reference, the line of sight of the user looking only at one point, and the user does not need to sequentially gaze at a plurality of points.

With such a configuration, the user can quickly move an input element, which he/she wishes to input, into the display region R2 by looking at a position far from the reference position P. On the other hand, the user can finely move the inputted input element by looking at a position near the reference position P.

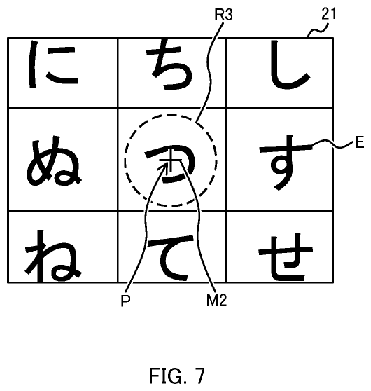

The input receiving section 114 receives the input of the input element from the user when a predetermined condition is satisfied. FIG. 7 is a schematic diagram showing the display section 21 displaying the input screen. The display section 21, as the input screen, displays a plurality of input elements E included in the display region R2 and the mark M2 indicating the reference position P. The mark M2 indicating the reference position P may be omitted.

In FIG. 7, an input region R3 is represented by broken lines. The input region R3 is a predetermined region including the reference position P. The size and shape of the input region R3 are set in advance. The input region R3 is a circle having a predetermined radius with the reference position P as a center in the example of FIG. 7, but may be another shape such as a rectangle, a polygon, or the like. The size of the input region R3 is preferably set to a size such that one input element E can be positioned in the input region R3 and two or more input elements E cannot be simultaneously positioned in the input region R3.

When any one input element E, among the plurality of input elements E included in the display region R2, is positioned in the input region R3, the input receiving section 114 initiates a time count. The input receiving section 114 detects that the input element E is positioned in the input region R3 by one of the followings: (1) a representative point (center point, etc.) of the input element E is positioned in the input region R3, (2) at least a part of the input element E overlaps with the input region R3, and (3) the input element E overlaps with the reference position P.

When the input element E positioned in the input region R3 is changed to another input element E, the input receiving section 114 resets the time count and initiates a time count again. When the time count for one input element E reaches or exceeds a predetermined time (e.g., 5 seconds), the input receiving section 114 receives that input element E as the input from the user.

The output section 115 causes the storage section 13 to store the input information indicating the input element which the input receiving section 114 has received as the input from the user. Also, the output section 115 may output the input information which is received by the input receiving section 114 as the input from the user to another external device via the interface 12.

As described above, since the line-of-sight input device 1 according to the present embodiment receives the input of the input element on the basis of the relationship (that is, the direction and distance) between the reference line of sight and the current line of sight, the calibration can be performed only by identifying the user's line of sight when the user looks at one point of the reference position P as the reference line-of-sight. This facilitates the calibration since the user does not need to sequentially gaze at the plurality of points.

Also, since the line-of-sight input device 1 displays a part of the entire region including all the input elements as the display region and moves the display region according to the user's line of sight, the respective input elements are displayed larger than when the display region is not moved. As a result, since the user does not need to precisely gaze at a small region corresponding to the input element and only needs to gaze at a large region, the user can easily select the input element.

The display control section 112 may cause the display section 21 to display the input element (i.e., turn on the display section 21) during a period when the line-of-sight input device 1 is receiving the input from the user, and does not need to cause the display section 21 to display the input element (i.e., turn off the display section 21) during a period when the line-of-sight input device 1 is not receiving the input from the user. Whether the line-of-sight input device 1 is receiving or not receiving the input from the user can be switched by, for example, the user performing a predetermined operation on the operation device 3. Therefore, since the line-of-sight input device 1 presents the input element to the user only during the period when receiving a character input, the user can easily determine whether or not the character input is possible.

Furthermore, the display section 21, using a transparent display, may be configured to be switchable between a transparent state in which a light is transmitted and a non-transparent state in which a light is not transmitted. In this case, the display control section 112 may switch to the non-transmissive state, in which a light is not transmitted, during a period in which the line-of-sight input device 1 is performing the calibration or receiving the input from the user, and may switch to the transmissive state, in which a light is not transmitted, when the line-of-sight input device 1 is not in the aforementioned period. By doing this, the user can look ahead with both eyes when the calibration is not performed and when the character input is not performed.

### Flow of the Method of Line-of-Sight Input

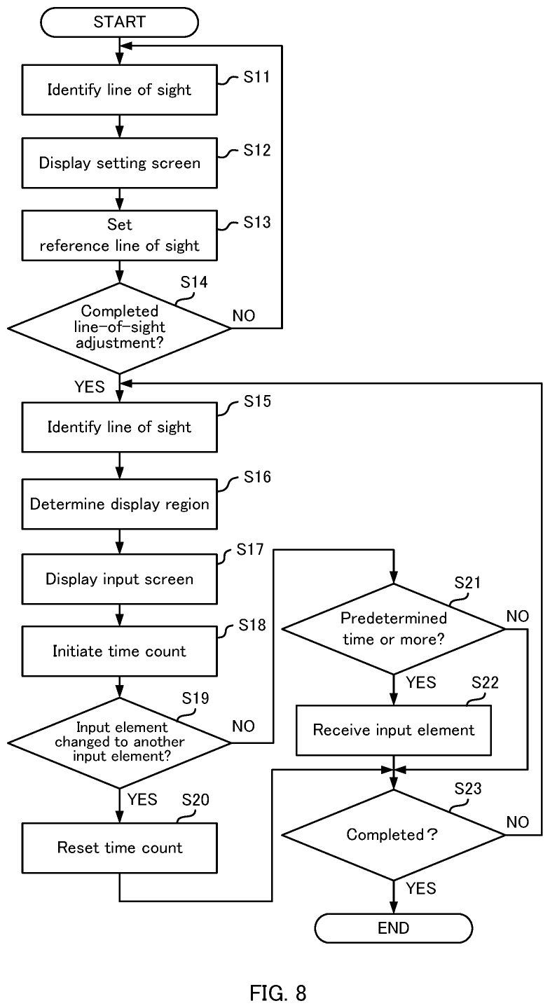

FIG. 8 is a flowchart showing the method of line-of-sight input according to the present embodiment. The flow of FIG. 8 starts, for example, when the user wears the head-mounted device 2. First, the line-of-sight identification section 111 performs the calibration by identifying the user's line of sight using the captured image captured by the imaging section 22 of the head-mounted device 2 while causing the display control section 112 to display the mark M2 which indicates a reference position P (S11). The display control section 112 transmits signals to the display section 21 of the head-mounted device 2 to display the setting screen for setting the reference line of sight (S12).

The reference setting section 113 identifies, as the reference line of sight, a line of sight when the user is looking at the reference position P according to the displayed contents of the setting screen (S13). If the reference line of sight cannot be identified and the calibration has not been completed (NO in S14), the line-of-sight input device 1 returns to the step S11 and repeats the process.

After the calibration is completed (YES in S14), the line-of-sight identification section 111 identifies the user's line of sight by using the captured image captured by the imaging section 22 of the head-mounted device 2 (S15) in order to receive an input.

The display control section 112 determines, as a display target, a display region which is a partial region of an entire region showing all the input elements of the input element information (S16). At the start of receiving an input from the user, the display control section 112 sets the display region in the entire display region to a predetermined position (initial position). Thereafter, the display control section 112 calculates a movement speed of the display region on the basis of a relationship between (i) the reference line of sight identified by the reference setting section 113 and (ii) the user's current line of sight identified by the line-of-sight identification section 111, and determines the display region in the entire region using the calculated movement speed.

The display control section 112 transmits, to the display section 21 of the head-mounted device 2, information indicating the initial position or the display region after being moved, and displays an input screen for receiving the input from the user (S17). The input receiving section 114 initiates or continues a time count for any one input element, among the plurality of input elements included in the display region, positioned in a predetermined input region including the reference position (S18).

When the input element for which the time count is performed is changed to another input element (YES in S19), the input receiving section 114 resets the time count (S20), and the process proceeds to step S23.

When the input element for which the time count is performed is not changed to another input element (NO in S19) and the time count reaches or exceeds a predetermined time (YES in S21), the input receiving section 114 receives the input element for which the time count is performed as the input from the user (S22). When the time count does not reach or exceed the predetermined time (NO in S21), the input receiving section 114 proceeds to step S23.

When a predetermined termination condition (for example, when the user removes the head-mounted device 2 or performs a predetermined termination operation on the line-of-sight input device 1) is not satisfied (NO in S23), the line-of-sight input device 1 returns to step S15 and repeats the process. When the predetermined termination condition is satisfied (YES in S23), the line-of-sight input device 1 ends the process.

In FIG. 8, the calibration process and the input receiving process are performed continuously, but the calibration process and the input receiving process may be performed independently of each other. For example, the line-of-sight input device 1, after performing the calibration process once, may perform the input receiving process a plurality of times. Further, the line-of-sight input device 1 may perform the calibration process again when the head-mounted device 2 is removed from the user's head and worn again, or when the user performs an operation of a calibration instruction using the operation device 3.

### Effects of Embodiments

According to the present embodiment, since the line-of-sight input device 1 receives the input of the input element on the basis of the relationship (i.e., the direction and distance) between the reference line of sight and the current line of sight, the calibration can be performed by simply identifying, as the reference line of sight, a line of sight with which the user looks at one point of the mark M2, which indicates the reference position P. Since the head-mounted device 2 is fixed to the user's head, the calibration does not need to be performed again even if the user moves, and therefore it is possible to reduce the number of calibrations. For a human, gazing at a peripheral area that is away from what is straight in front of him/her by moving only the eyes is more difficult than gazing straight in front. Therefore, it would be a burden for a user to perform a calibration by looking at the plurality of points as in the technique described in Patent Document 1. In contrast, the line-of-sight input system S according to the present embodiment can reduce the burden on the user at the time of the calibration, since the user can set the reference line of sight just by looking at one point.

In addition, the line-of-sight input device 1 displays a part of the entire region including all the input elements as the display region, and determines the input from the user by moving the display region according to the user's line of sight. For this reason, the line-of-sight input device 1 can display each input element larger in comparison to the case where the entire region is displayed, and therefore the user can easily select the input element without having to precisely gaze one of a number of input elements. If the user continues to look at the input element that he/she wishes to input, the movement speed of the desired input element becomes slower as the desired input element comes closer to the input region R3, and therefore, it is easy to position the desired input element in the input region R3.

The present disclosure is explained on the basis of the exemplary embodiments. The technical scope of the present disclosure is not limited to the scope explained in the above embodiments and it is possible to make various changes and modifications within the scope of the disclosure. For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

The control section 11 (processor) of the line-of-sight input device 1 is the main component of the steps (processes) included in the method of line-of-sight input shown in FIG. 8. That is, the control section 11 executes the method of line-of-sight input shown in FIG. 8 by reading a program for executing the method of line-of-sight input shown in FIG. 8 from the storage section 13 and executing the program to control the respective sections of the line-of-sight input device 1. The steps included in the method of line-of-sight input shown in FIG. 8 may be partially omitted, the order of the steps may be changed, or a plurality of steps may be performed in parallel.

What is claimed is:

1. A line-of-sight input device for a user to input information using a line of sight, comprising:
a line-of-sight identification section that identifies the line of sight of the user;
a reference setting section that causes a storage section to store, as a reference line of sight, the line of sight being identified by the identification section when the user is looking at a reference position in a display fixed to the head of the user;
a display control section that causes the display to display a partial region of an entire region representing a plurality of input elements that can be inputted to the line-of-sight device, and changes a position of the partial region in the entire region, the partial region being displayed to the display, on the basis of a relationship between the reference line of sight and the line of sight identified by the line-of-sight identification section; and
an input receiving section that receives an input of an input element positioned in a predetermined region including the reference position within the partial region displayed on the display.

2. The line-of-sight input device according to claim 1, wherein the display control section moves the position of the partial region in the entire region to be displayed to the display along a vector from the reference line of sight to the line of sight identified by line-of-sight identification section.

3. The line-of-sight input device according to claim 2, wherein the display control section changes a movement speed of the partial region on the basis of a difference between the reference line of sight and the line of sight identified by the line-of-sight's identification section.

4. The line-of-sight input device according to claim 2, wherein the display control section stops a movement of the partial region when the difference between the reference line of sight and the line of sight identified by line-of-sight identification section is equal to or smaller than a predetermined value.

5. The line-of-sight input device according to claim 1, wherein the input receiving section receives the input element that has been positioned in the predetermined region for a predetermined time or more, as an input from the user.

6. The line-of-sight input device according to claim 1, wherein the reference setting section sets the reference line of sight after the display control section causes the display to display information prompting the user to look at the predetermined point in the display.

7. The line-of-sight input device according to claim 1, wherein the reference setting section sets the reference line of sight according to an operation of an operation device operated by the user.

8. The line-of-sight input device according to claim 1, wherein the display control section causes the display to display the partial region during a period in which the input receiving section receives the input from the user, and causes the display not to display the partial region during a period in which the input receiving section does not receive the input from the user.

9. The line-of-sight input device according to claim 8, wherein the display control section switches to a state where the display does not transmit a light during a period in which the input receiving section receives the input from the user, and switches to a state in which the display transmits a light during a period in which the input receiving section does not receive the input from the user.

10. A method of line-of-sight input for a user to input information using a line of sight in a line-of-sight input device and performed by a processor, comprising:
identifying the line of sight of the user;
causing a storage section to store, as a reference line of sight, the line of sight being identified in the identifying when the user is looking at a reference position in a display fixed to the head of the user;
causing the display to display a partial region of an entire region representing a plurality of input elements that can be inputted to the line-of-sight input device, and changing a position of the partial region in the entire region, the partial region being displayed to the display, on the basis of a relationship between the reference line of sight and the line of sight identified in the identifying; and
receiving an input of an input element positioned in a predetermined region including the reference position within the partial region displayed on the display.

11. A line-of-sight input system having a head-mounted device fixed to the head of a user and a line-of-sight input device that transfers signals from and to the head-mounted device, wherein the head-mounted device includes a display fixed to the head of the user so that the user can perform visual recognition,
the line-of-sight input device includes:
a line-of-sight identification section that identifies a line of sight;
a reference setting section that causes a storage section to store, as a reference line of sight, the line of sight being identified by the identification section when the user is looking at a reference position in the display; and
a display control section that causes the display to display a partial region of an entire region representing a plurality of input elements that can be inputted to the line-of-sight input device, and changes a position of the partial region in the entire region, the partial region being displayed to the display, on the basis of a relationship between the reference line of sight and the line of sight identified by the line-of-sight identification section; and
an input receiving section that receives an input of an input element positioned in a predetermined region including the reference position within the partial region displayed on the display.
